(19) United States
(12) Patent Application Publication
(10) Pub. No.: US 2006/0093284 A1
(43) Pub. Date: May 4, 2006

(54) Semiconductor laser diode

(75) Inventor: Chang Ho Song, Seoul (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Samsung Electro-Mechanics Co., Ltd., Suwon (KR)

(21) Appl. No.: 11/089,778

(22) Filed: Mar. 25, 2005

(30) Foreign Application Priority Data
Oct. 28, 2004 (KR) 10-2004-0086483

(51) Int. Cl. G02B 6/36

(52) U.S. Cl. 385/92

(57) ABSTRACT

Disclosed herein is a semiconductor laser diode to be assembled with a holder centrally perforated with an insertion cavity. The laser diode comprises a laser device, a frame unit, a resin unit, and at least one air passage. The resin unit includes a resin frame formed on the frame unit to surround the laser device while forming a light emission aperture. The air passage is formed at a surface of the resin frame perpendicular to an optical axis of a laser beam emitted through the light emission aperture, thereby defining at least one air channel between the resin frame and the insertion cavity in an assembled state with the holder. The air channel, defined at a boundary between the resin unit and the holder, is used as an outside air inflow and outflow passage, causing an improvement in heating source cooling and heat radiation characteristics of the laser diode.

### RELATED APPLICATIONS

The present application is based on, and claims priority from, Korean Application Number 2004-86483, filed Oct. 28 2004,

the disclosure of which is incorporated by reference herein in its entirety.

### BACKGROUND OF THE INVENTION

1. Field of the Invention

The present invention relates to a semiconductor laser diode, and more particularly, to a semiconductor laser diode in which at least one air channel, for use as an outside air inflow and outflow passage, is defined at a boundary plane between a resin unit thereof and a holder assembled thereto, thereby being capable of achieving an improvement in heating source cooling and heat radiation characteristics thereof.

2. Description of the Related Art

In general, semiconductor laser diodes operate by making use of electrical and optical properties of pn-junction semiconductor laser devices causing laser oscillation through forward current injection. The semiconductor laser diodes are widely applied to the field of data storage and optical pickup devices, such as for example, pointer, laser printer, scanner, CD-P, CD-ROM, CD-RW, DVD-P, or DVD-ROM.

FIG. 9 illustrates an example of a conventional semiconductor laser diode disclosed in WO 2002/7275 (Jan. 24, 2002). As shown in FIG. 9, the conventional semiconductor laser diode, designated as reference numeral 1, comprises a frame 2 provided at an upper surface thereof with a fixed sub-mount 3, a laser device 4 disposed and fixed at an upper surface of the sub-mount 3, and a resin fastener 5 for use in the integration of the frame 2.

The frame 2 includes a plurality of frame structures, namely, a main frame structure 6 on which the laser device 4 is mounted, and auxiliary wiring frame structures 7 and 8 separated from the main frame structure 6. The main frame structure 6 and the auxiliary frame structures 7 and 8 are integrated to one another by means of the resin fastener 5, so as to form a frame package.

The main frame structure 6 is divided into a device arrangement portion 6a, a lead portion 6b serving as a current passage, and left and right wing portions 6c and 6d for use in heat radiation and position determination of the laser device 4. In addition, the main frame structure 6 has a thick base portion 6e and a thin base portion 6f, which borders each other in the vicinity of a connection region between the device arrangement portion 6a and the lead portion 6b. Due to a thickness difference therebetween, both the thick and thin base portions 6e and 6f define a stepped boundary 9.

The resin fastener 5 includes a resin frame 5b having a U-shaped cross section. The U-shaped resin frame 5b surrounds an upper surface of the main frame structure 6 and defines a light emission aperture 5a at a tip end of the upper surface of the main frame structure 6.

The conventional semiconductor laser diode 1 configured as stated above, as shown in FIG. 10, is assembled with a holder 10 in which an insertion cavity 11 is centrally perforated through a holder body. As a result of being assembled with the holder 10, the semiconductor laser diode 1 is mounted in an optical pickup device.

At opposite inner surfaces of the insertion cavity 11 of the holder 10 are formed position-determining grooves 12, respectively, so that the left and right wing portions 6c and 6d of the main frame structure 6 are fitted, respectively, into the grooves 12, In order to determine an insertion position of the laser diode 1 into the insertion cavity 11.

As stated above, in order to mount the semiconductor laser diode 1 in the optical pickup device, the laser diode 1 must be first assembled with the holder 10 as it is inserted in the insertion cavity 11 of the holder 10, and in such an assembled state, the laser device 4, the main frame structure 6 and the resin fastener 5 are located in the insertion cavity 11 of the holder 10, and the auxiliary frame structures 7 and 8 and the lead portion 6b are exposed to the outside of the holder 10.

In the above described assembled structure of the conventional laser diode 1 and the holder 10, however, as can be seen from FIG. 10, when the resin fastener 5 is disposed in the insertion cavity 11 of the holder 10, upper and lower surfaces of the resin fastener 5 come into surface contact with corresponding opposite inner surfaces of the insertion cavity 11, and the resin frame 5b of the resin fastener 5 completely closes the insertion cavity 11 in a light emission direction, thereby disabling formation of an air stream. As a result, it is impossible to introduce outside air into the insertion cavity 11, or to discharge inside air to the outside.

In this case, when a laser beam from the laser device 4 is emitted to the outside through the light emission aperture 5a, the laser device 4 as a heating source is only restrictively cooled as the heat generated in the laser device 4 is transferred to the wing portions 6c and 6d and the thick portion 6e for heat radiation, as opposed to a direct cooling manner wherein the laser device 4 come into direct contact with the air stream. This causes degradation in a heat radiation characteristic of the laser diode, exacerbating a thermal load and overheating of the laser device, and being a cause of thermal damage to the laser diode.

### SUMMARY OF THE INVENTION

Therefore, the present invention has been made in view of the above problems, and it is an object of the present invention to provide a semiconductor laser diode which can form an air stream coming into contact with a resin unit and a laser device as a heating source for enabling heat exchange therebetween, and can widen a heat radiation area obtainable from the resin unit, thereby being capable of achieving an improvement in a heat radiation characteristic thereof.

In accordance with the present invention, the above and other objects can be accomplished by the provision of a semiconductor laser diode configured to be assembled with a holder centrally perforated through a body thereof with an insertion cavity, comprising: a laser device mounted at a surface of a sub-mount; a frame unit on which the sub-mount is mounted; and a resin unit for use in integration of the frame unit, wherein the resin unit includes a resin frame formed at a surface of the frame unit so as to surround the laser device while forming a light emission aperture, and wherein the semiconductor laser diode further comprises at least one air passage formed at a surface of the resin frame perpendicular to an optical axis of a laser beam emitted through the light emission aperture, thereby defining at least one air channel between the resin frame and the insertion cavity in an assembled state with the holder.

Preferably, the air passage may have a polygonal cross section, such as a triangular or rectangular cross section.

Preferably, the air passage may have an arc-shaped cross section.

Preferably, the air passage may have a straight form extending along approximately the same axis as the optical axis.

Preferably, the air passage may include a single recess formed at the surface of the resin frame in a direction of the optical axis and having approximately the same width as a width of the light emission aperture.

Preferably, a width center of the single recess may be aligned on approximately the same axis as the laser device.

Preferably, the air passage may include two or more recesses formed at the surface of the resin frame in a direction of the optical axis and each having a width smaller than that of the light emission aperture.

Preferably, one of the two or more recesses may be aligned on approximately the same axis as the laser device.

Preferably, the air passage may include a twice folded cross sectional recess configured so that entrance and exit openings having widths smaller than that of the light emission aperture are connected to each other through a connection recess formed at the surface of the resin frame in a width direction.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 illustrate a semiconductor laser diode in accordance with a first embodiment of the present invention, FIG. 1 being a perspective view, FIG. 2a being a front view, and FIG. 2b being a sectional view taken along line A-A′ shown in FIG. 2a;

FIGS. 3 and 4 illustrate a semiconductor laser diode in accordance with a second embodiment of the present invention, FIG. 3 being a perspective view, FIG. 4a being a front view, and FIG. 4b being a sectional view taken along line B-B′ shown in FIG. 4a;

FIGS. 5 and 6 illustrate a semiconductor laser diode in accordance with a third embodiment of the present invention, FIG. 5 being a perspective view, FIG. 6a being a front view, and FIG. 6b being a sectional view taken along line C-C′ shown in FIG. 6a;

FIG. 7 is a perspective view illustrating an assembled state of a holder and semiconductor laser diode in accordance with the present invention;

FIGS. 8a and 8b are sectional views illustrating the assembled state of the holder and semiconductor laser diode in accordance with the present invention, FIG. 8a being a cross sectional view taken along line D-D′ shown in FIG. 7, and FIG. 8b being a longitudinal sectional view taken along an optical axis X;

FIG. 9 is a perspective view illustrating a semiconductor laser diode in accordance with the prior art; and

FIG. 10 is a sectional view illustrating an assembled state of a holder and semiconductor laser diode in accordance with the prior art.

### DESCRIPTION OF THE PREFERRED EMBODIMENTS

Now, preferred embodiments of the present invention will be explained in detail with reference to the accompanying drawings.

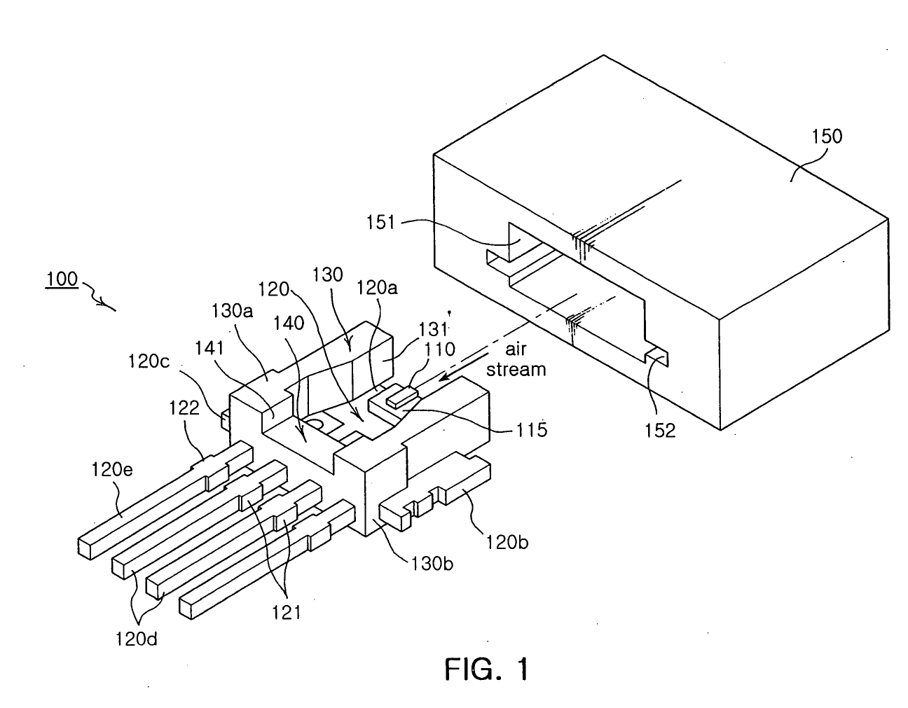

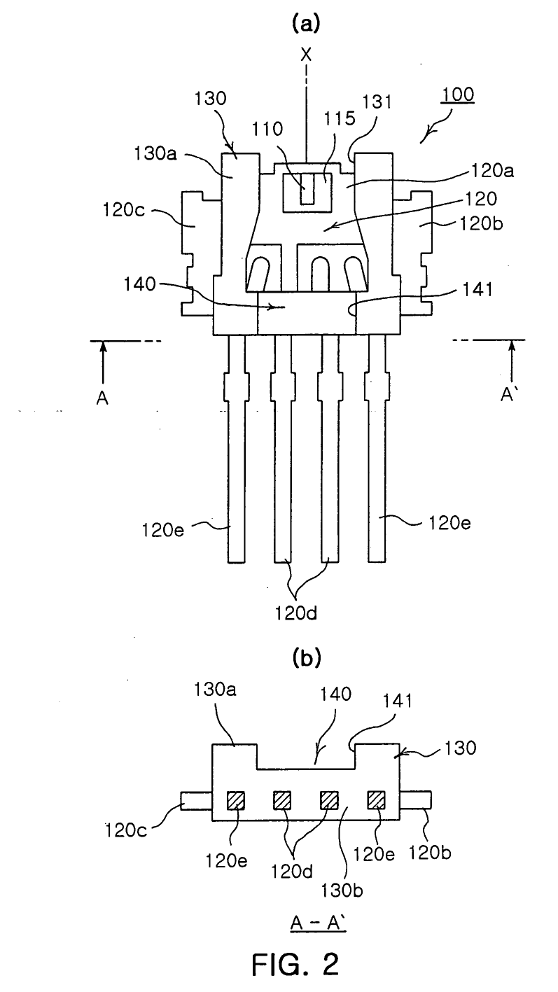

FIGS. 1 to 2b illustrate a semiconductor laser diode in accordance with a first embodiment of the present invention, FIG. 1 being a perspective view, FIG. 2a being a front view, and FIG. 2b being a sectional view taken along line A-A′ shown in FIG. 2a.

As shown in FIGS. 1 to 2b, the semiconductor laser diode 100 of the present invention is configured in such a fashion that it can form an air stream for use in heat exchange between outside air and heat generated upon laser beam emission operation, and can widen a heat radiation area, thereby being capable of achieving an improvement in cooling and heat radiation characteristics thereof. The semiconductor laser diode 100 according to the present embodiment comprises a laser device 110, a frame unit 120, a resin unit 130 and an air passage 140.

The laser device 110 is a light emitting device fixedly bonded to an upper surface of a sub-mount 115. The sub-mount 115 is mounted in the vicinity of a front end of an upper surface of the frame unit 120.

Here, the laser device 110 is formed by wrapping an active layer with a clad layer, and is made of a material selected from among a GaAlAs-based material, AlGain, AlGainP or AlGainPAs-based material for use in red semiconductor laser devices of high-density optical discs, and GaN-based material for use in electronic devices, such as a transistor.

The laser device 110 is fixedly bonded to the upper surface of the sub-mount 115 by means of a soldering agent, such as Au—Sn or Pb—Sn, or other adhesive means, such as Ag paste.

The sub-mount 115, for use as a light receiving element, is made of Si, and can monitor light emitted from a rear end of the laser device 110. Such a sub-mount 115 is also made of highly heat-conductive ceramic or metal material, such as for example, AlN, SiC, Cu, etc., in addition to Si.

The sub-mount 115 is fixedly bonded to the upper surface of the frame unit 120 by means of a soldering agent, such as Au—Sn, Pb—Sn, Au—Sn or Sn—Bi, or other adhesive means, such as Ag paste.

The frame unit 120 includes a device arrangement portion 120a, left and right wing portions 120b and 120c, lead frames 120d, and auxiliary frames 120e.

The device arrangement portion 120a is a frame having a flat surface exposed to the outside. With such a configuration, the sub-mount 115, on which the laser device 110 is mounted, is bonded to the exposed flat surface of the device arrangement portion 120a by making use of a soldering agent or paste. The device arrangement portion 120a is surrounded by a resin frame of the resin unit 130.

The left and right wing portions 120b and 120c are frames extending in opposite directions from left and right ends of the device arrangement portion 120a, so as to be exposed to the outside at left and right sides of the resin unit 130. The left and right wing portions 120b and 120c serve to radiate heat generated upon the light emission operation of the laser device 110. When the semiconductor laser diode 100 is assembled with a pickup device holder 150, the left and right wing portions 120b and 120c are guided along position-determining guiding grooves 152 formed at opposite inner surfaces of the holder 150 defining an insertion cavity 151, serving to determine the assembly position of the semiconductor laser diode 100.

The one or more lead frames 120d are plated cooper members forming a current passage, and each takes a rectangular cross section extending rearward from a rear end of the device arrangement portion 120a by a predetermined length. At a longitudinal intermediate position of the lead frame 120d is formed a protruding portion 121.

The auxiliary frames 120e have the same length as that of the lead frames 120d, and are arranged at opposite left and right sides of the lead frames 120d. Each of the auxiliary frames 120e is electrically connected to the laser device 110 or the sub-mount 115 by way of a not-shown wire, and at a longitudinal intermediate position of the auxiliary frame 120e is formed a protruding portion 122.

The resin unit 130, made of an insulating resin material, includes a resin frame 130a and resin base 130b, so as to surround the frame unit 120 for the integration thereof.

The resin frame 130a has a U-shaped cross section so that it surrounds the upper surface of the frame unit 120 while defining a light emission aperture 131 at a front end of the device arrangement portion 120a so as to expose the laser device 110 to the outside. The resin base 130b is configured to cover the entire lower surface of the frame unit 120. With such a configuration, the laser device 110 can be protected by means of the resin frame 130a, and a laser beam emitted from the laser device 110 can progress forward through the light emission aperture 131 without interference.

Both the resin frame 130a and the resin base 130b are transfer molded, respectively, to the front and rear surfaces of the frame unit 120 by making use of the insulating resin material, such as polycarbonate resin or epoxy resin, so that the device arrangement portion 120a is exposed to the outside at a front side of the resin frame 130a and the left and right wing portions 120b and 120c are exposed to the outside at left and right sides of the resin frame 130a. The resin frame 130a and the resin base 130b also serve to integrate the lead frames 120d and the auxiliary frames 120e to the device arrangement portion 120a.

Meanwhile, when the semiconductor laser diode 100 is inserted into the insertion cavity 151 centrally perforated through the body of the holder 150 so as to be assembled with the holder 150, the air passage 140 is defined at a rear end surface of the resin frame 130a, perpendicular to an optical axis of a laser beam emitted forward through the light emission aperture 131, to have a predetermined depth. Thereby, the air passage 140 forms at least one air channel between the rear end surface of the resin frame 130a and a facing inner surface of the insertion cavity 151 for allowing outside air to be introduced into the insertion cavity 151 so as to form an air stream coming into contact with the laser device 110 as a heating source.

In this case, preferably, the depth of the air passage 140 is determined to expose the upper surface of the frame unit 120 to the outside in a rearward direction.

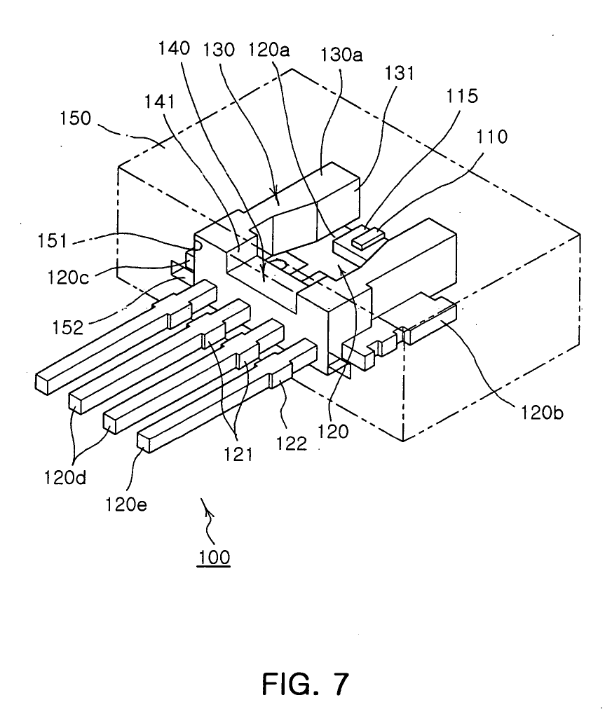

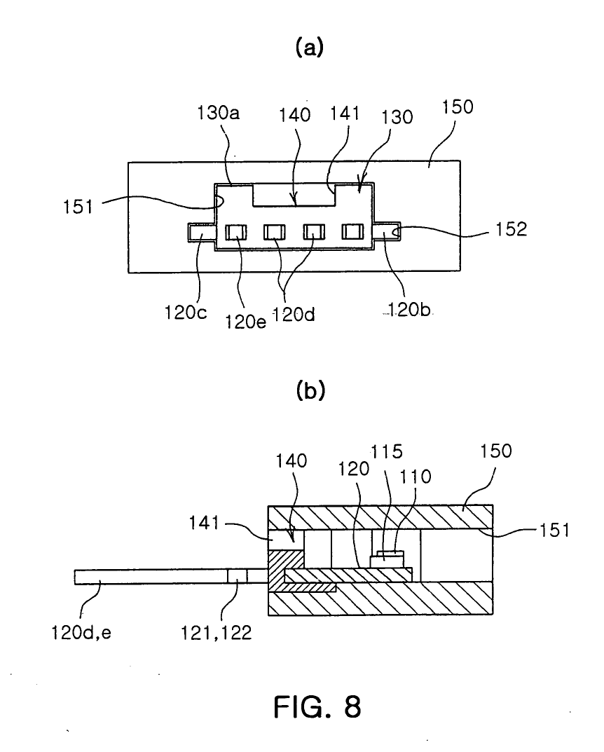

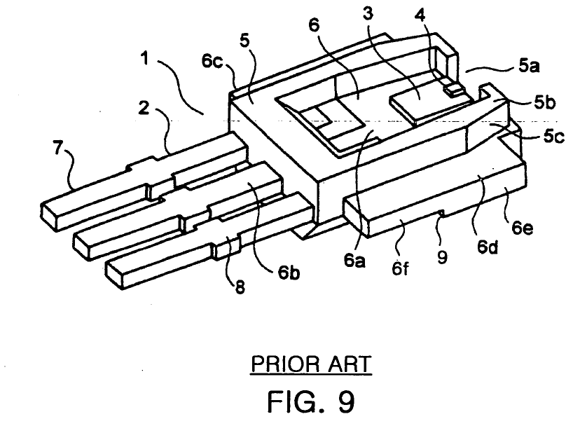

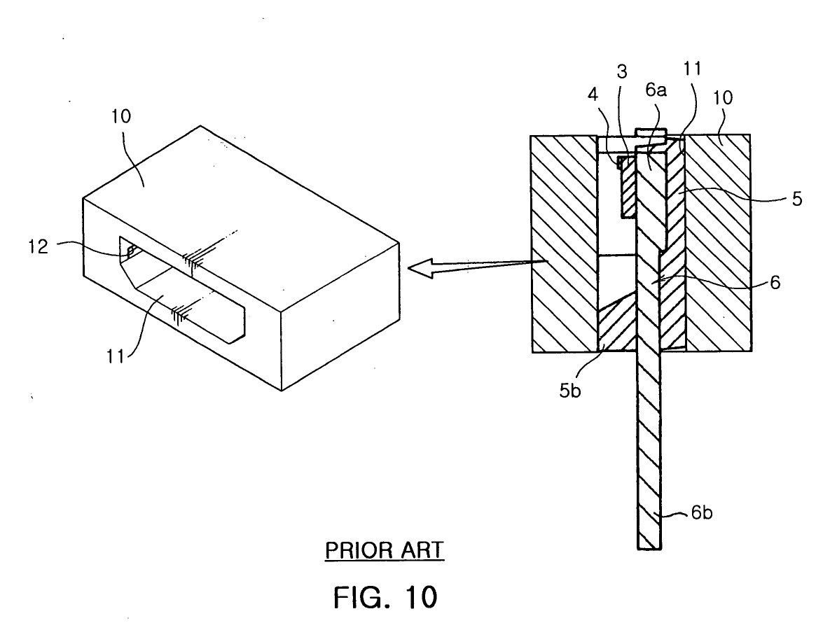

When the laser diode 100 is assembled with the holder 150 as shown in FIGS. 7 and 8, the air passage 140 of the present embodiment can form at least one air channel having a predetermined size between the rear end surface of the resin frame 130a and the facing inner surface of the insertion cavity 151.

Here, the air passage 140 has a polygonal cross section, such as a triangular or rectangular cross section, but not limited thereto, and thus is allowable to have an arc-shaped cross section. As a result of such various cross sectional shapes of the air passage 140, there is achieved a variation in a contact area between the resin unit 130 and the air passing through the air passage 140.

Preferably, the air passage 140 is straightly formed so that the air passing through the air passage 140 straightly flows from the outside to the insertion cavity 151 along approximately the same axis as the optical axis X.

As shown in FIGS. 1 and 2, the air passage 140 includes a single recess 141 formed at the rear end surface of the resin frame 130a perpendicular to the optical axis X. The recess 141 has approximately the same width as that of the light emission aperture 131.

In this case, in order to improve a cooling efficiency of the air for use in heat exchange of the laser device 110, preferably, the width center of the single recess 141 is positioned on approximately the same axis as the laser device 110.

Thereby, the air, introduced through the light emission aperture 131 from the outside, forms an air stream flowing to the lead frames 120d by passing through the single recess 141. In this case, the introduced air acts to cool the laser device 110 as the heating source and the device arrangement portion 120a heated upon affection of the heating source through heat exchange while coming into contact with them. After heat exchange completion, the used air is discharged to the outside from the insertion cavity 151.

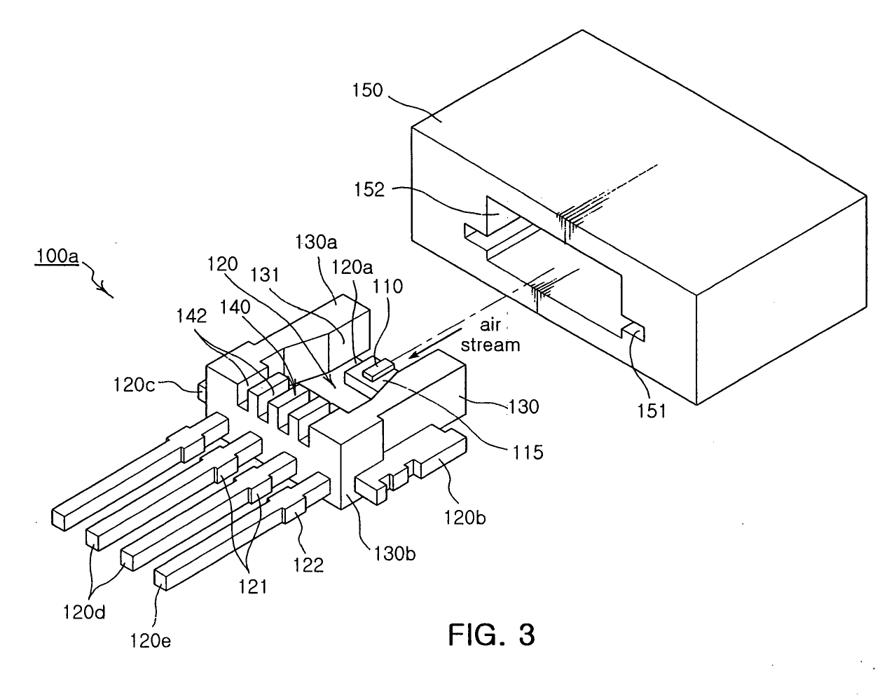

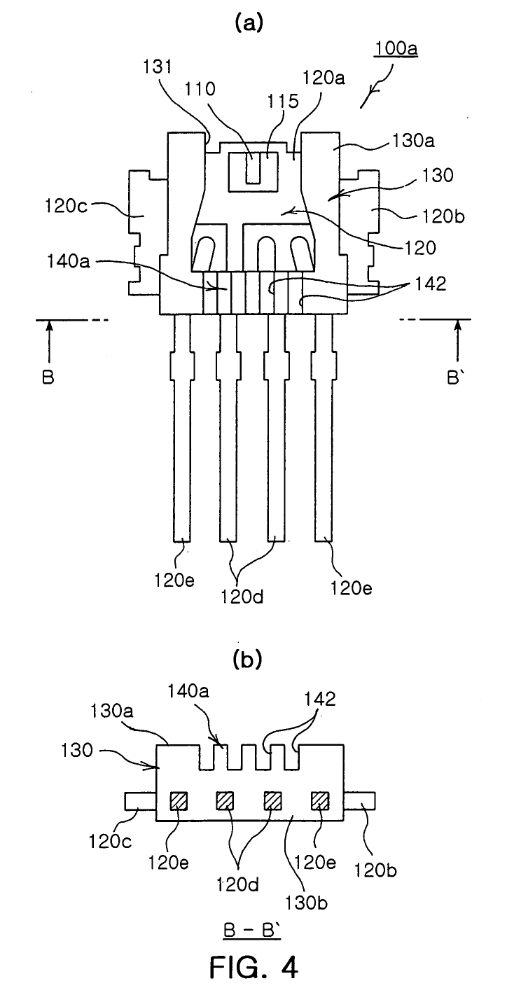

FIGS. 3 and 4 illustrate a semiconductor laser diode in accordance with a second embodiment of the present invention, FIG. 3 being a perspective view, FIG. 4a being a front view, and FIG. 4b being a sectional view taken along line B-B′ shown in FIG. 4a. As shown in FIGS. 3 to 4b, similar to the first embodiment, the laser diode 100a according to the present embodiment comprises the laser device 110, the frame unit 120, the resin unit 130 and an air passage 140a. In the present embodiment, the same elements as those of the first embodiment are denoted by the same reference numerals, and their detailed description will be omitted.

The air passage 140a includes two or more recesses 142 formed at the rear end surface of the resin frame 130a perpendicular to the optical axis. The respective recesses 142 have a width smaller than that of the light emission aperture 131.

In this case, it is preferable that a plurality of the recesses 142 are equidistantly spaced apart from one another in a width direction, and have the same width as each other, and that one of the plurality of recesses 142 is aligned on approximately the same axis as the laser device 110 as the heating source.

In the present embodiment, when the laser diode 100a is assembled with the holder 150, the recesses 142 can form two or more air channels having a predetermined size between the rear end surface of the resin frame 130a and the facing inner surface of the insertion cavity 151.

Thereby, the air, introduced from the outside through the light emission aperture 131, forms an air stream flowing to the lead frames 120d through the recesses 142. In this case, the introduced air acts to cool the laser device 110 as the heating source and the device arrangement portion 120a heated upon affection of the heating source through heat exchange while coming into contact with them. After heat exchange completion, the used air is discharged to the outside from the insertion cavity 151.

In the present embodiment, as a result of forming the plurality of recesses 142 at the rear end surface of the resin frame 130a, the entire surface area of the air passage 140a is increased as compared to the air passage 140 of the first embodiment wherein the single recess 141 is formed at the rear end surface of the resin frame 130a. This increases a heat radiation area obtainable from the resin frame 130a, resulting in an improvement in the heat radiation characteristic of the semiconductor laser diode 100a using the resin unit 130.

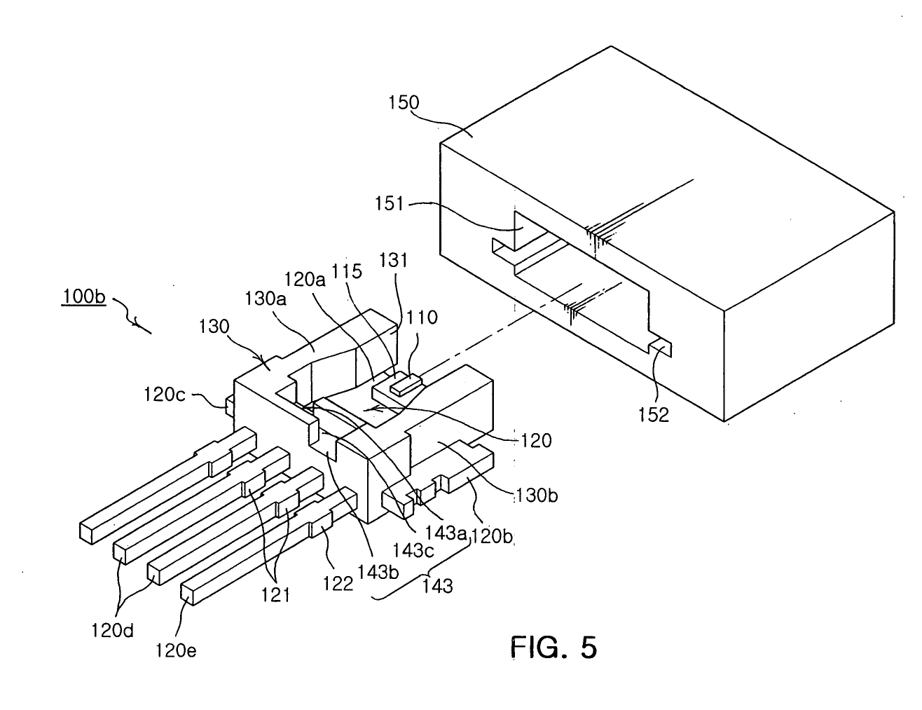

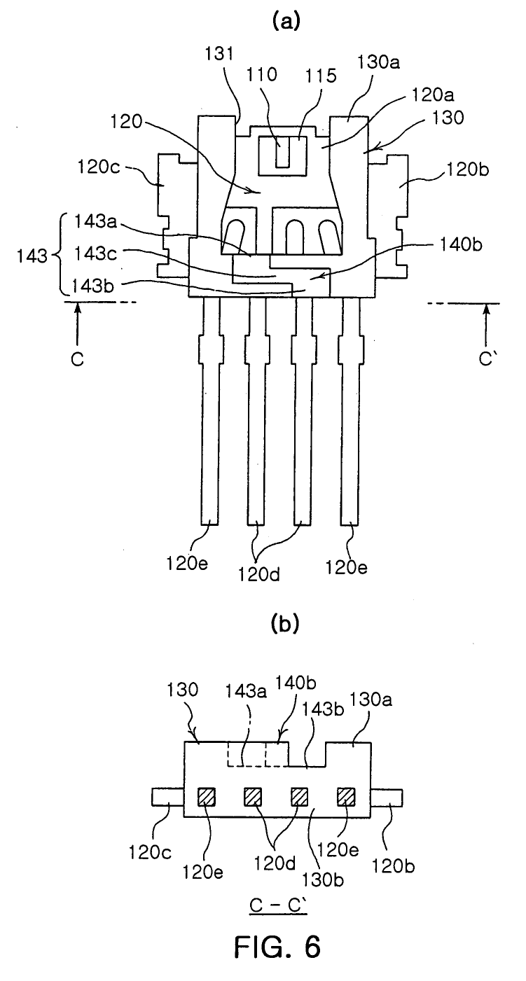

FIGS. 5 and 6 illustrate a semiconductor laser diode in accordance with a third embodiment of the present invention, FIG. 5 being a perspective view, FIG. 6a being a front view, and FIG. 6b being a sectional view taken along line C-C′ shown in FIG. 6a. As shown in FIGS. 5 to 6b , similar to the first and second embodiments, the laser diode 100b according to the present embodiment comprises the laser device 110, the frame unit 120, the resin unit 130 and an air passage 140b. In the present embodiment, the same elements as those of the first and second embodiments are denoted by the same reference numerals, and their detailed description will be omitted.

The air passage 140b includes a twice folded cross sectional recess 143 having a configuration that rectangular entrance and exit openings 143a and 143b having widths smaller than that of the light emission aperture 131 are connected to each other through a connection recess 143c internally defined in the rear end surface of the resin frame 130a perpendicular to the optical axis.

In the present embodiment, in order to lengthen an obtainable air channel, the twice folded cross sectional recess 143 is configured in such a fashion that the connection recess 143c extends rearward from the entrance opening 143a by a predetermined length and is folded at a right angle, and then is again folded at a right angle after extending laterally by a predetermined length, so as to be connected to the exit opening 143b, or that the connection recess 143 diagonally extends from the entrance opening 143a to the exit opening 143b.

In this case, when the laser diode 100b is assembled with the holder 150, the twice folded cross sectional recess 143 can form the lengthened air channel between the rear end surface of the resin frame 130a and the facing inner surface of the insertion cavity 151.

Thereby, the air, introduced from the outside through the light emission aperture 131, forms an air stream flowing to the lead frames 120d through the entrance opening 143a, connection recess 143c and exit opening 143b of the twice folded cross sectional recess 143. In this case, the introduced air acts to cool the laser device 110 as the heating source and the device arrangement portion 120a heated upon affection of the heating source through heat exchange while coming into contact with them. After heat exchange completion, the used air is discharged to the outside from the insertion cavity 151.

In the present embodiment, since the recess 143 achieves a longer air channel length as compared to the single recess 141 and the plurality of recesses 142, it has an effect of increasing a heat radiation area obtainable from the resin frame 130a, resulting in an improvement in the heat radiation characteristic of the semiconductor laser diode 100b using the resin unit 130.

As apparent from the above description, the present invention provides a semiconductor laser diode in which at least one air passage is formed at a surface of a resin frame perpendicular to an optical axis of a laser beam emitted through a light emission aperture, thereby being capable of defining at least one air channel in an assembled state with a holder. With such a configuration, outside air can be introduced into the semiconductor laser diode through the light emission aperture so as to come into contact with a laser device as a heating source as well as a device arrangement portion heated by the heating source, resulting in an increased heat exchange area. This achieves an effective cooling of the laser device and can widen a heat radiation area obtainable from a resin unit, resulting in an improvement in cooling and heat radiation characteristics of the semiconductor laser diode.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A semiconductor laser diode configured to be assembled with a holder centrally perforated through a body thereof with an insertion cavity, comprising:
a laser device mounted at a surface of a sub-mount;
a frame unit on which the sub-mount is mounted; and
a resin unit for use in integration of the frame unit, wherein the resin unit includes a resin frame formed at a surface of the frame unit so as to surround the laser device while forming a light emission aperture, and
wherein the semiconductor laser diode further comprises at least one air passage formed at a surface of the resin frame perpendicular to an optical axis of a laser beam emitted through the light emission aperture, thereby defining at least one air channel between the resin frame and the insertion cavity in an assembled state with the holder.

2. The diode as set forth in claim 1, wherein the air passage has a polygonal cross section, such as a triangular or rectangular cross section.

3. The diode as set forth in claim 1, wherein the air passage has an arc-shaped cross section.

4. The diode as set forth in claim 1, wherein the air passage has a straight form extending along approximately the same axis as the optical axis.

5. The diode as set forth in claim 1, wherein the air passage includes a single recess formed at the surface of the resin frame in a direction of the optical axis and having approximately the same width as a width of the light emission aperture.

6. The diode as set forth in claim 5, wherein a width center of the single recess is aligned on approximately the same axis as the laser device.

7. The diode as set forth in claim 1, wherein the air passage includes two or more recesses formed at the surface of the resin frame in a direction of the optical axis and each having a width smaller than that of the light emission aperture.

8. The diode as set forth in claim 7, wherein one of the two or more recesses is aligned on approximately the same axis as the laser device.

9. The diode as set forth in claim 1, wherein the air passage includes a twice folded cross sectional recess configured so that entrance and exit openings having widths smaller than that of the light emission aperture are connected to each other through a connection recess formed at the surface of the resin frame in a width direction.
